(19) United States
(12) Patent Application Publication
(10) Pub. No.: US 2007/0222125 A1
(43) Pub. Date: Sep. 27, 2007

(54) PLASTICIZING CYLINDER WITH INTEGRATED HEAT PIPES

(75) Inventor: Franz Grajewski, Fuchstal (DE)

Correspondence Address: Henry M. Feiereisen;Henry M. Feiereisen, LLC, Suite 4714, 350 Fifth Avenue, New York, NY, 10118, US

(73) Assignee: Krauss-Maffei Kunststofftechnik GbmH, Munchen (DE)

(21) Appl. No.: 11/688,483

(22) Filed: Mar. 20, 2007

(30) Foreign Application Priority Data
Mar. 24, 2006 (DE) 102006013691.8-16

(51) Int. Cl. B28B 3/00; C04B 35/64

(52) U.S. Cl. 264/645

(57) ABSTRACT

A plasticizing cylinder for processing plasticizable material includes a pressure jacket, at least one heating element disposed at one area of the pressure jacket, and at least one cooling element disposed at another area of the pressure jacket. Extending within a wall of the pressure jacket between the area of the heating element and the area of the cooling element is a plurality of heat pipes, with each heat pipe having at least one section constructed with a capillary structure.

### CROSS-REFERENCES TO RELATED APPLICATIONS

This application claims the priority of German Patent Application, Serial No. 10 2006 013 691.8-16, filed Mar. 24, 2006, pursuant to 35 U.S.C. 119(a)-(d), the content of which is incorporated herein by reference in its entirety as if fully set forth herein.

### BACKGROUND OF THE INVENTION

The present invention relates, in general, to a plasticizing cylinder, and more particularly to a plasticizing cylinder for use in injection molding machines or extruders for processing plasticizable material.

Nothing in the following discussion of the state of the art is to be construed as an admission of prior art.

Plastic parts can be made through injection molding or extrusion processes. When demanding high quality of finished plastic parts, i.e. plastic parts having defined material properties and precise dimensions, the control system has to be designed highly sophisticated. To date, plasticizing cylinders are generally equipped with electrical heater bands and so-called heating and cooling elements by which the material to be plasticized can be heated or heat can be removed via the cylinder wall of the plasticizing cylinder. Cooling involves the use of fans in combination with a heater band to adjust a certain temperature level on the cylinder wall.

Another approach involves the provision of bores in the pressure jacket of the plasticizing cylinder for receiving a heat carrier medium. In this way, energy can be supplied to or removed from the material to be plasticized also via the cylinder wall. The cooling zone is located at an inlet area of the material to be plasticized whereas the heating zone is situated at an outlet area of the plasticizing cylinder.

Examples of “plasticizable material” include plastics and/or rubber, in particular polyolefins in general, PVC, styrene polymers such as ABS (Acrylnitril-Butadien-Styrol), or polystyrenes, elastomers, thermosets, and the like.

For process-related reasons, insufficient energy is dissipated in a first zone of the plasticizing cylinder by the shear action of a transport screw into the material to be plasticized, as the transport screw rotates so that this zone requires additional heating action to melt the material. Cooling is normally applied in a second zone of the plasticizing cylinder in order to remove excess energy. In other words, such a system does not operate efficiently enough because the need for a cooling element to remove energy that has been introduced by the heating element is energetically uneconomic. Moreover, the thermal insulation of heater bands and in particular of the heating and cooling elements is generally poor, causing significant thermal loss power.

It would therefore be desirable and advantageous to provide an improved plasticizing cylinder to obviate prior art shortcomings.

### SUMMARY OF THE INVENTION

According to one aspect of the present invention, a plasticizing cylinder for processing plasticizable material includes a pressure jacket, at least one heating element disposed at one area of the pressure jacket, at least one cooling element disposed at another area of the pressure jacket, and a plurality of heat pipes extending within a wall of the pressure jacket between the area of the heating element and the area of the cooling element, wherein each heat pipe has at least one section constructed with a capillary structure.

According to another feature of the present invention, at least some of the heat pipes have at least one section which may be constructed with a lattice structure to form the capillary structure in an area of an inner wall surface of the heat pipes.

According to another feature of the present invention, each of the heat pipes may have a recess or a bore or may be constructed in the form of a recess or a bore which extends in the pressure jacket between the area of the heating element and the area of the cooling element. Instead or in addition, it is also possible to configure the at least one section, having the capillary structure, in the recess or bore of the pressure jacket.

In the following description, the term “capillary structure” relates to a region which is circulated, at least temporarily, by a fluid, whereby capillary forces are instrumental in transporting the fluid, preferably a liquid, between two zones.

According to another feature of the present invention, the heat pipes are formed by bores extending longitudinally in the pressure jacket of the plasticizing cylinder. As an alternative, the plasticizing cylinder may also be constructed of two parts, with an outer tube having an inner wall surface formed with grooves, and an inner tube to close the grooves. In other words, the outer tube with the grooves forms in combination with the inner tube the flow paths for the heat pipes. The flow paths for the heat pipes may be configured in such a manner that the cross section thereof, in particular of the grooves, is square, rectangular, polygonal, circular, or oval. It is, of course, also conceivable to construct the plasticizing cylinder with heat pipes of different configurations and different cross sectional configurations or combinations thereof. The connection between the inner and outer tubes for realizing the pressure jacket with the heat pipes may be realized in any suitable manner, e.g. through a force-fitting engagement and/or material connection, e.g. welding.

According to another feature of the present invention, the capillary structure may be configured form at least a further fluid connection between a condensation side and an evaporation side of the heat pipes. Suitably, the capillary structure is arranged about the entire inner wall surface of the heat pipe(s), whereby the lattice structure is provided such as to form the capillary structure in combination with the inner wall of the heat pipes. Of course, the lattice structure can be configured so as to attain a spontaneous capillary structure for transport of a fluid within the heat pipes.

According to another feature of the present invention, the lattice structure may be realized in the form of a braiding of wire or the like to form essentially an outer boundary which corresponds to the inner structure of the heat pipe and/or which has a length which corresponds substantially to the length of the heat pipes. The lattice structure, or at least sections thereof, for realizing the capillary structure can be placed in the bores of the pressure jacket or in tubular elements received in the pressure jacket to form the heat pipes, and may be made of metal, such as stainless steel, brass, copper, bronze, steel, such as steel wool, or alloys, or of plastic, such as PVC, polyurethane, or a combination thereof, or of ceramics, composites and/or combinations thereof.

According to another feature of the present invention, the capillary structure in the heat pipes may be arranged such that at least a portion of a heating fluid is forced to flow from the condensation side back to the evaporation side, i.e. in opposition to the primary fluid flow direction of the heating fluid in the free cross section of the heat pipe.

According to another feature of the present invention, the heating fluid may be a medium selected from the group consisting of water, water with additive, or coolant, and the like. When selecting a heating fluid, it should be taken into consideration that the fluid, depending on the temperature level between evaporation side and condensation side of the pressure jacket, may be present, at least in part, in a gaseous or a liquid state of aggregation.

According to another feature of the present invention, at least one pressure sensor and/or temperature sensor may be disposed in an area of the pressure jacket, in particular for determining respective state variable of the heating fluid.

According to another feature of the present invention, the pressure jacket has an end zone which may be formed with at least one annular groove which is in fluid communication with the heat pipes. In this way, heating fluid can be fed and discharged and the overall system can be supplied with fluid.

According to another feature of the present invention, an insulation may be arranged in coaxial surrounding relationship to the pressure jacket. The insulation may hereby be made of glass wool or glass braiding.

A plastics processing machine equipped with a plasticizing cylinder according to the invention can be operated at considerably less energy consumption because excess energy is no longer removed from the system but transferred to different areas that need more energy input. In other words, energy is transport to a location where a change in temperature takes place as a result of dissipation, i.e. normally the evaporation side, and to a location where the heating fluid condenses. The thermal insulation by means of the insulation minimizes loss power and an even temperature distribution is realized as a result of the interconnection of the heat pipes, even across the circumference of the plasticizing cylinder. As a result, the plastics processing machine can be operated to satisfy even highest quality demands.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view of a plasticizing cylinder according to the present invention, showing in greater detail on a right hand side a portion of the plasticizing cylinder, taken along the line I-I in FIG. 2; and

FIG. 2 is a cross section of the plasticizing cylinder, taken along the line II-II in FIG. 1.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

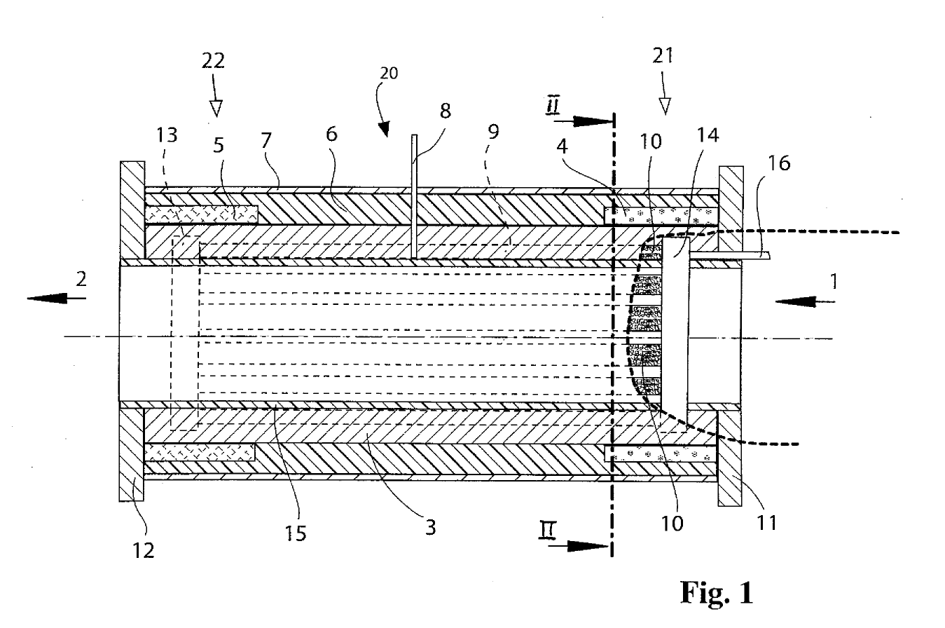

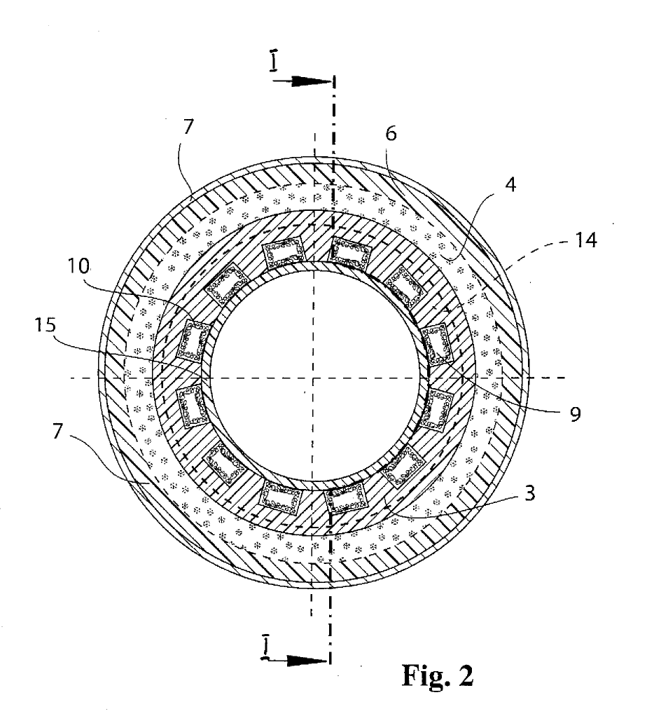

Turning now to the drawing, and in particular to FIG. 1, there is shown a schematic side view of a plasticizing cylinder according to the present invention, showing in greater detail on a right hand side a portion of the plasticizing cylinder, taken along the line I-I in FIG. 2.

The plasticizing cylinder has an inlet on a right-hand side, designated by arrow 1, and an outlet on a left-hand side, designated by arrow 2, for material to be plasticized, with the arrows 1, 2 depicting the preferred transport direction of the material flow. The plasticizing cylinder accommodates a transport screw, not shown in detail for the sake of simplicity, and includes a pressure jacket 3 extending between end pieces 11, 12. In the area of the inlet 1, the plasticizing cylinder has cooling elements 4, which are arranged on an outside surface of the pressure jacket 3, and in the area of the outlet 2, the plasticizing cylinder has heating elements 5, which are also arranged on the outside surface of the pressure jacket 3. Placed in coaxial surrounding relationship to the pressure jacket 3 is an insulation 6 which is embraced by an outer envelope 7. Disposed in midsection of the plasticizing cylinder is a sensor assembly 8, comprising a pressure sensor and/or temperature sensor, for ascertaining state variables, such as pressure and/or temperature, of the heating fluid in particular.

The material to be plasticized flows through the plasticizing cylinder and has a temperature T_{E} in an area of the inlet 1 and a temperature T_{A} in an area of the outlet 2, whereby the temperature T_{E} is lower than the temperature T_{A}.

Disposed inside the pressure jacket 3 are heat pipes 9 in which a lattice structure is received that is configured to form a capillary structure 10 on the inside, as shown in particular in FIG. 2. The heat pipes 9 extend from an evaporation side 22 to a condensation side 21. The heat pipes 9 are fluidly connected on the evaporation side 22 by an annular groove 13 and on the condensation side 21 by an annular groove 14. In this way, temperature compensation can be realized across the circumference of the pressure jacket 3. The heat pipes 9 may be constructed to extend along the entire length of the pressure jacket 3 or may be configured in the form of zones, and are provided to maintain the cylinder wall along the length of the pressure jacket 3 at an even temperature. The sensor assembly 8 determines hereby the actual state variable, such as pressure and/or temperature of the heating fluid within the heat pipes 9. In particular, when using water as the heating fluid, the sensor assembly predefines the actual temperature value for the temperature control because, as is generally known per se, the vapor pressure and the fluid temperature are directly coupled with one another via the evaporation temperature.

In the non-limiting example of the drawing, the heat pipes 9 are formed by longitudinal grooves directly on the inside of the pressure jacket 3 and define with the capillary structure 10 and an inner closing cylinder or tube 15 a flow path for the heating fluid, as clearly shown in FIG. 2. A return flow of heating fluid from the condensation side 21 to the evaporation side 22 is implemented at least in part within the capillary structure 10.

The heat pipes 9 receive heating fluid via at least one feed pipe 16 which ports into the annular groove 14, as shown by way of example in FIG. 1.

FIG. 2 shows in particular the incorporation of the lattice structure to provide the capillary structure 10 on the inner wall surfaces of the heat pipes 9, on one hand, and to enable the midsection of the plasticizing cylinder for use as substantial flow cross section for the heating fluid from the evaporation zone 22 to the condensation zone 21.

Apart from the temperature compensation realized by the interconnection of the heat pipes 9 via the annular grooves 13, 14 at the end zones of the pressure jacket 3, the efficiency of the plasticizing cylinder is further improved by the insulation 6 outside the pressure jacket 3. The insulation 6 may hereby be made of glass wool or glass braiding. This ensures a further reduction of loss power.

Although the foregoing description sets forth the implementation of the heat pipes in the form of grooves on the inside of the pressure jacket 6 to define a fluid flow cross section in combination with the inner tube 15, i.e. a two-part construction of inner and outer tubes, it is, of course, also conceivable to construct the pressure jacket 6 with internal length bores to form respective heat pipes. The capillary system is hereby realized in the bores by inserting respective lattice sleeve for example. The heat pipes 9 may also be realized by incorporating tubular elements in the pressure jacket 3 and placing the lattice structure for the capillary structure 10 in the interior of the tubular elements.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A plasticizing cylinder for processing plasticizable material, comprising:
a pressure jacket;
at least one heating element disposed at one area of the pressure jacket;
at least one cooling element disposed at another area of the pressure jacket; and
a plurality of heat pipes extending within a wall of the pressure jacket between the area of the heating element and the area of the cooling element, each said heat pipe having at least one section constructed with a capillary structure.

2. The plasticizing cylinder of claim 1, wherein at least some of the heat pipes have at least one section which is constructed with a lattice structure to form the capillary structure in an area of an inner wall surface of the heat pipes.

3. The plasticizing cylinder of claim 1, wherein the heat pipes are each formed by a recess or a bore extending in the pressure jacket between the area of the heating element and the area of the cooling element.

4. The plasticizing cylinder of claim 2, wherein the at least one section is formed in a recess or bore extending in the pressure jacket between the area of the heating element and the area of the cooling element.

5. The plasticizing cylinder of claim 1, wherein the capillary structure forms at least one fluid connection between a condensation side and an evaporation side of the heat pipes.

6. The plasticizing cylinder of claim 5, wherein the capillary structure in the heat pipes is arranged such that at least a portion of a heating fluid is forced to flow from the condensation side back to the evaporation side.

7. The plasticizing cylinder of claim 1, wherein the lattice structure is made of at least one material selected from the group consisting of metal, plastic, ceramics, composites, and any combination thereof.

8. The plasticizing cylinder of claim 7, wherein the metal is selected from the group consisting of stainless steel, brass, copper, bronze, steel, and alloys.

9. The plasticizing cylinder of claim 7, wherein the plastic is selected from the group consisting of PVC, polyurethane, and a combination thereof.

10. The plasticizing cylinder of claim 6, wherein the heating fluid is a medium selected from the group consisting of water, water with additive, and coolant.

11. The plasticizing cylinder of claim 1, further comprising at least one sensor disposed in an area of the pressure jacket and selected from the group consisting of pressure sensor and temperature sensor.

12. The plasticizing cylinder of claim 1, wherein the pressure jacket has an end zone formed with at least one annular groove which is in fluid communication with the heat pipes.

13. The plasticizing cylinder of claim 1 for use in the plasticization of plastics and/or rubber for making an injection-molded part or an extruded part.

14. The plasticizing cylinder of claim 1, wherein the pressure jacket is made of two parts and includes an outer tube having an inner wall surface formed with grooves, and an inner tube to close the grooves to thereby form the heat pipes.

15. The plasticizing cylinder of claim 1, further comprising an insulation in coaxial surrounding relationship to the pressure jacket.

16. The plasticizing cylinder of claim 15, wherein the insulation is made of glass wool or glass braiding.
